(19) United States
(12) Patent Application Publication
(10) Pub. No.: US 2008/0008028 A1
(43) Pub. Date: Jan. 10, 2008

(54) MIXING VESSEL ALIGNMENT SYSTEMS, DEVICES, AND RELATED METHODS

(75) Inventors: Alexandre N. TERENTIEV, Lexington, KY (US); Sergey TERENTYEV, Lexington, KY (US)

Correspondence Address: KING & SCHICKLI, PLLC, 247 NORTH BROADWAY, LEXINGTON, KY, 40507, US

(73) Assignee: LEVTECH, INC., Lexington, KY (US)

(21) Appl. No.: 11/571,066

(22) PCT Filed: Jun. 22, 2005
(86) PCT No.: PCT/US05/21798

§ 371 Date: Dec. 21, 2006

Related U.S. Application Data
(60) Provisional application No. 60/582,926, filed on Jun. 23, 2004.
(60) Provisional application No. 60/611,538, filed on Sep. 20, 2004.

(51) Int. Cl. B01F 13/08

(52) U.S. Cl. 366/273

(57) ABSTRACT

Various alignment systems, devices, and related methods are for use in associated with the mixing of fluid in a vessel, such as a flexible bag, using an internal fluid-agitating element driven by an external motive device.

This application claims the benefit of U.S. Provisional Patent Applications Ser. No. 60/582,926, filed Jun. 23, 2004 and Ser. No. 60/611,538, filed Sep. 20, 2004, the disclosures of which are incorporated herein by reference.

### TECHNICAL FIELD

The present invention relates generally to fluid agitation and, more particularly, to various systems, devices, and related methods for aligning an external motive device or drive unit with a vessel, such as a flexible bag, including a fluid-agitating element.

### BACKGROUND OF THE INVENTION

Most pharmaceutical solutions and suspensions manufactured on an industrial scale require highly controlled, thorough mixing to achieve a satisfactory yield and ensure a uniform distribution of ingredients in the final product. Rocking or rotating agitator tanks are frequently used to complete the process, but a better degree of mixing is normally achieved by using a mechanical stirrer or impeller (e.g., a set of mixing blades attached to a metal rod). Typically, the mechanical stirrer or impeller is simply lowered into the fluid through an opening in the top of the vessel and rotated by an external motor to create the desired mixing action.

One significant limitation or shortcoming of such an arrangement is the danger of contamination or leakage during mixing. The shaft carrying the mixing blades or impeller is typically introduced into the vessel through a dynamic seal or bearing. This opening provides an opportunity for bacteria or other contaminants to enter, which of course can lead to the degradation of the product. A corresponding danger of environmental contamination exists in applications involving hazardous or toxic fluids, or suspensions of pathogenic organisms, since dynamic seals or bearings are prone to leakage. Cleanup and sterilization are also made difficult by the dynamic bearings or seals, since these structures typically include folds and crevices that are difficult to reach. Since these problems are faced by all manufacturers of sterile solutions, pharmaceuticals, or the like, the U.S. Food and Drug Administration (FDA) has consequently promulgated strict processing requirements for such fluids, and especially those slated for intravenous use.

In an effort to overcome these problems, others have proposed alternative mixing technologies. Perhaps the most common proposal for stirring a fluid under sterile conditions is to use a fluid-agitating element in the form of rotating, permanent magnet bar covered by an inert layer of TEFLON, glass, or the like. The magnetic “stirrer” bar contacts the bottom of the agitator vessel and rotated by a driving magnet positioned external to the vessel. An example of may be found in U.S. Pat. No. 5,947,703 to Nojiri et al., incorporated herein by reference.

Of course, the use of such an externally driven magnetic bar avoids the need for a dynamic bearing, seal or other opening in the vessel to transfer the rotational force from the driving magnet to the stirring magnet. Therefore, a completely enclosed system is provided. This of course prevents leakage and the potential for contamination created by hazardous materials (e.g., cytotoxic agents, solvents with low flash points, blood products, etc.), eases clean up, and allows for the desirable sterile environment to be advantageously maintained.

Despite the advantages of this type of mixing system and others where the need for a shaft penetrating into the vessel or dynamic seal is eliminated, a substantial problem is the difficulty in efficiently and effectively coupling a fluid-agitating element with an external motive device providing the rotation and/or levitation force. For example, when a vessel in the form of a flexible bag is proximate to the motive device, the relative location of the fluid-agitating element may be unknown. In the case of a small (10 liter or less) transparent bag, it may be possible to manipulate the bag relative to the motive device or vice-versa to ensure that the fluid-agitating element is “picked up” and the desired coupling formed. However, this is considered inconvenient and time consuming, especially if fluid is already present in the bag.

Moreover, in the case where the bag is relatively large (e.g., capable of holding 100 liters or more), formed of an opaque (e.g., black) material, or containing a cloudy fluid, achieving the proper positioning of the fluid-agitating element relative to the external motive device is at a minimum difficult, and in many cases, impossible. In the absence of fortuity, a significant amount of time and effort is required to lift and blindly reposition the bag relative to the motive device, without ever truly knowing that the coupling is properly formed. If the coupling ultimately cannot be established in the proper fashion, the desired fluid agitation cannot be achieved in a satisfactory manner, which essentially renders the set up useless. These shortcomings may significantly detract from the attractiveness of such fluid agitation systems from a practical standpoint.

Thus, a need is identified for an improved manner of ensuring that the desired coupling may be reliably and efficiently achieved between a fluid-agitating element in a vessel such as a bag and an external motive device, such as one supplying the rotational force that causes the element to agitate the fluid, even in large, industrial scale mixing bags or vessels (greater than 100 liters), opaque bags or vessels, or where the fluid to be agitated is not sufficiently clear. The improvement provided by the invention would be easy to implement using existing manufacturing techniques and without significant additional expense. Overall, a substantial gain in efficiency and ease of use would be realized as a result of the improvement, and would greatly expand the potential applications for such advanced mixing bag systems.

### SUMMARY OF THE INVENTION

In accordance with a first aspect of the invention, an alignment system for use with a motive device for a fluid-agitating element in a flexible bag and a rigid container including an opening through which a coupling may be formed between the fluid-agitating element and the motive device is disclosed. The device comprises a locator projection for associating with the bag adjacent the fluid-agitating element and the opening in the container. An interface includes a first end for receiving the locator projection and a second end for receiving at least a portion of the motive device. As a result, the interface assists in aligning the locator projection and hence the adjacent fluid-agitating element with the motive device through the opening.

In one embodiment, the first end of the interface includes a planar face including a center aperture for receiving the locator projection. The second end of the interface is tubular and includes a tapered surface for guiding the motive device into alignment with the fluid-agitating element. The interface may comprise a single piece of material, or instead the first end and second ends may comprise first and second parts, respectively.

Additionally, the device may include means for holding the interface adjacent the locator projection. In one embodiment, the holding means comprises a clamp including jaws for gripping a portion of the locator projection adjacent the first end of the interface. In the situation where the fluid-agitating element is at least partially magnetic, the holding means may form a magnetic coupling with the fluid-agitating element to hold the first end adjacent the locator projection.

In use, the interface may be attached to and supported by the rigid container. Alternatively, the interface may be attached to and supported by the bag. It is also possible for one part of the interface to associate with the rigid container while another associates with the bag.

The device may further include a stand for supporting the rigid container. The stand includes a support part for positioning in the opening of the rigid container and engaging the interface. A first bearing associated with the motive device is received in a guide associated with the stand. The terminal end of the guide corresponds to a generally aligned position of a portion of the motive device for positioning adjacent the fluid-agitating element.

In one embodiment, the guide is comprised of a pair of spaced rails, each including a notch adjacent the terminal end. This notch captures the first bearing such that a portion of the motive device for positioning adjacent the fluid-agitating element substantially aligns with the opening in the container. Preferably, a second end of the motive device is associated with a second bearing for engaging a corresponding end of the stand to suspend the motive device therefrom.

In accordance with a further aspect of the invention, an alignment device is disclosed for use in a mixing system including a fluid-agitating element rotated by an external motive device in a vessel including a locator projection adjacent the fluid-agitating element. The device comprises an interface having a first end for receiving the locator projection and a second end for receiving at least a portion of the motive device. The second end includes a tapered surface for guiding the motive device into alignment with the fluid-agitating element.

In accordance with still another aspect of the invention, a device for supporting and aligning a bag is disclosed for use in a mixing system in which an external motive device rotates a fluid-agitating element in a flexible bag carrying a locator projection. The device comprises a rigid container for receiving the bag and including an opening associated with an interface. The interface includes a tapered surface for guiding the motive device into alignment with the locator projection through the opening.

In accordance with yet another aspect of the invention, a support arrangement for a rigid container for receiving a flexible bag including a fluid-agitating element capable of being rotated by a motive device is disclosed. The arrangement comprises a stand for receiving and supporting the container. The stand also supports a guide adjacent the opening for guiding the motive device into alignment with the fluid-agitating element through the opening in the container.

In accordance with still a further aspect of the invention, another alignment device is disclosed for use in a mixing system including a fluid-agitating element rotated in a flexible bag by an external motive device, the bag having a port and being positioned in a rigid container. The device comprises an elongated support structure for spanning between spaced ends of the container, the support structure including an elongated opening for receiving the port. Means for associating the port with the support structure is also provided.

In one embodiment, the support structure includes a depending portion for engaging an inner surface of the container at each spaced end. The port or an adjacent portion of the bag may include a first flange and the associating means includes a bifurcated end having a first side for engaging the first flange and a second side for engaging an upper surface the support structure. The associating means may comprise a second flange for engaging a lower surface of the support structure, as well as a pivoting member for capturing the flange therein.

In accordance with still another aspect of the invention, a rigid container for use in connection with a mixing system including a fluid-agitating element rotated by an external motive device in a flexible bag is disclosed. The container includes an open-ended upstanding base having a floor and an opening for exposing the fluid-agitating element in the bag to the motive device. A temporary extender for removably mating with the open end of the base to increase the capacity of the container is also provided, and may be removed for manually accessing the floor.

In accordance with yet a further aspect of the invention, a method of aligning a motive device with a fluid-agitating element in a flexible bag through an opening in a rigid container is described. The method comprises associating a first end of an interface with a locator projection carried by the bag and associating a second end of the interface with the motive device. The interface thus assists in aligning the locator projection and hence the fluid-agitating element with the motive device through the opening in the rigid container.

The method may further include inserting the locator projection through a center aperture formed in a planar face at a first end of the interface. Preferably, the second end of the interface is tubular for receiving the motive device and includes a tapered surface, in which case the method comprises engaging a head end forming part of the motive device at least partially with the tapered surface during the step of associating the second end of the interface in order to establish alignment with the fluid-agitating element. Still further, the method may include the steps of: (1) assembling the interface from a first part including the first end and a second part including the second end; (2) coupling the interface with the bag adjacent the locator bore (which may comprise forming a magnetic coupling between an external holder and the fluid-agitating element in the bag); (3) associating the interface with the opening in a floor of the rigid container; or (4) suspending the motive device from a stand supporting the container in substantial alignment with the interface.

In accordance with yet an additional aspect of the invention, a method of aligning a motive device with a fluid-agitating element in a vessel is disclosed. The method comprises associating a first end of an interface with the vessel and associating a second tapered end of the interface with the motive device. The tapered surface helps to align these two structures with each other.

In accordance with a further aspect of the invention, a method for supporting and aligning a motive device with a fluid-agitating element positioned in a flexible bag carrying a locator projection and rotated by an external motive device is disclosed. The method comprises positioning the bag in a rigid container including an opening associated with an interface. The interface includes a tapered surface for guiding the motive device into alignment with the locator projection through the opening.

According to still another aspect of the invention, a method of supporting a rigid container for receiving a flexible bag including a fluid-agitating element capable of being rotated by a motive device is detailed. This method includes the step of associating the motive device with a guide adjacent an opening in the rigid container in alignment with the fluid-agitating element, and then forming a magnetic coupling between the motive device and the fluid-agitating element. The method may further include the steps of: (1) moving the motive device into alignment with the opening before or during a suspending step that associates the motive device with the guide; (2) associating the motive device with a different container; (3) associating the motive device with a different flexible bag; or (4) aligning the motive device with the fluid-agitating element through an interface by the opening in the container.

In accordance with another aspect of the invention, a method of suspending a port of a bag in a rigid container is disclosed. The method comprises spanning an elongated support structure including an elongated opening for slidably receiving the port between spaced ends of the container, preferably in general alignment with the port. The method also comprises connecting the port with the support structure, which may be accomplished by passing a coupler having a bifurcated end between a flange adjacent the port and the support structure. The method may further include the step of moving the port within the elongated opening before the connecting step.

According to one more aspect of the invention, a method of forming a rigid container for supporting a bag including a fluid-agitating element rotated by an external motive device to mix a fluid contained therein is disclosed. The method comprises: (1) providing a base with an open end and having an opening in a sidewall for exposing the fluid-agitating element in the bag to the motive device; (2) mating an extender with the base to increase the capacity of the container; and (3) removing the extender from the base. The method may further include coupling the fluid-agitating element with the external motive device through the opening.

### Brief Description of the Drawings

FIGS. 1, 1a, 1b and 1c are partially schematic, partially cross-sectional side views of one embodiment of a vessel in the form of a bag having a flexible portion and a rigid portion;

FIG. 2 is a partially schematic, partially cross-sectional side view showing the bag of FIG. 1 positioned in a rigid container, with the fluid-agitating element aligned with and levitated/rotated by an adjacent motive device or drive unit;

FIGS. 3a and 3b are partially schematic, partially cross-sectional side views of a flexible vessel with a rigid portion for aligning a fluid-agitating element with a external structure, wherein the fluid-agitating element is directly supported by a slide bearing;

FIGS. 4a-4b are side schematic views illustrating one embodiment of an alignment device according to one aspect of the invention;

FIGS. 5a-5b are side schematic views illustrating another alignment device;

FIGS. 5c-5d are side/top views of an elevated stand and rigid container in combination;

FIGS. 5e, 5f, and 5g are side views of the overall mixing arrangement using the alignment device of FIGS. 5a and 5b;

FIGS. 6a-6c are side schematic and cross-sectional views of a third alignment device;

FIGS. 7a-7c and 8a-8b are side and end views schematically illustrating an alignment device forming another aspect of the invention;

FIGS. 9a-9b are views of another embodiment of a device for supporting a port; and

FIGS. 10a-10c are side views of a multi-part rigid container for use with the mixing arrangements disclosed herein.

### DETAILED DESCRIPTION OF THE INVENTION

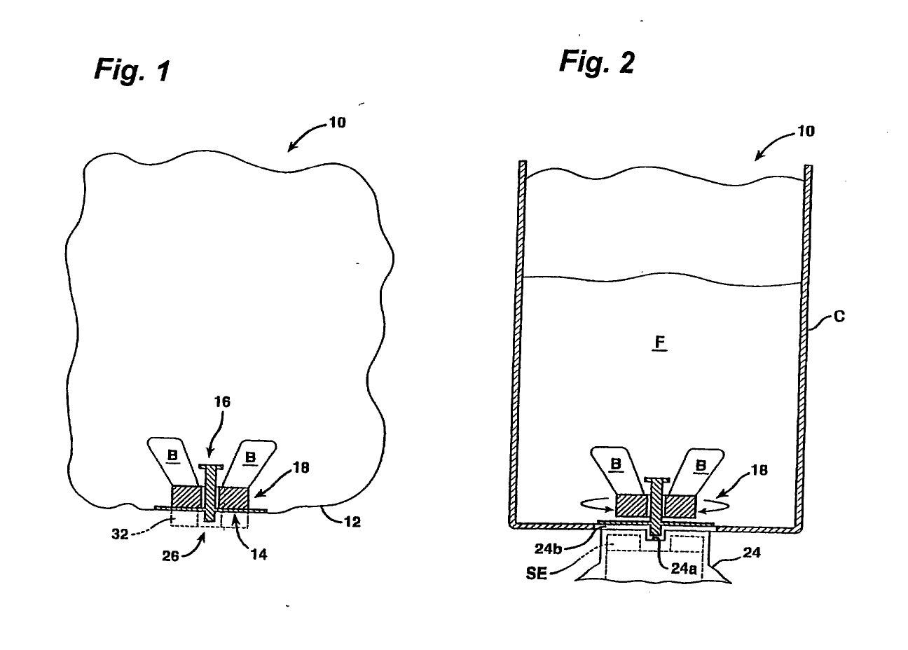

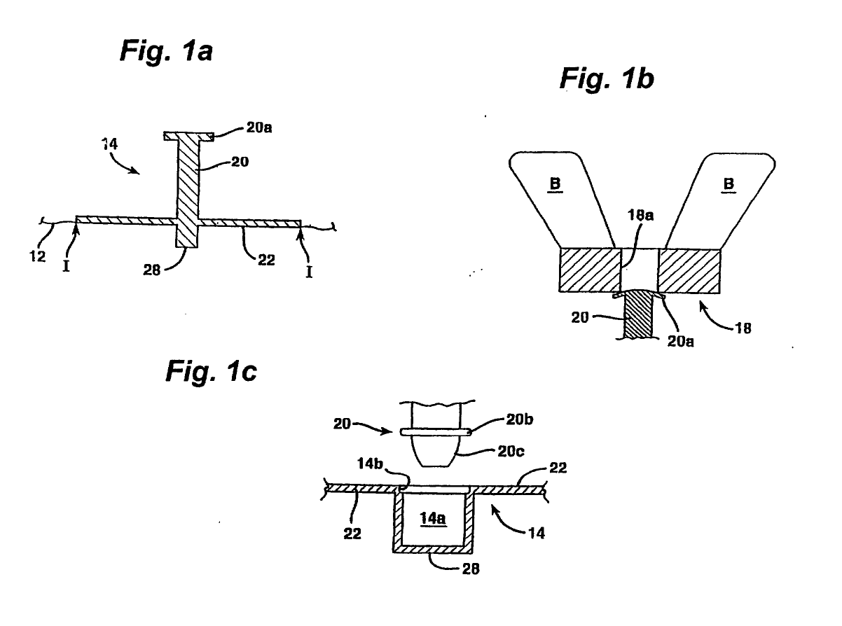

Referring to FIG. 1, it depicts a one embodiment of a mixing vessel arrangement for use with the alignment systems, devices, and method of the present invention. In this embodiment, the mixing vessel arrangement takes the form of a bag 10 including a body having a flexible or non-rigid portion 12, which is illustrated schematically, and a rigid or stiff portion 14, which is shown in cross-section. However, as outlined further in the description that follows, the use of the many of the present inventive concepts disclosed herein with completely rigid vessels is also possible.

The bag 10 may be hermetically sealed and may have one or more openings or fittings (not shown) for introducing or recovering a fluid. Alternatively, the bag 10 may be unsealed or open-ended. The particular geometry of the bag 10 employed normally depends on the application and is not considered critical to the invention. For example, in the case of a sterile fluid, a hermetically sealed, pre-sterilized bag with an aseptic fitting might be desirable; whereas, in the case where sterility is not important, an open-ended or unsealed bag might be suitable. The important point is that the bag 10 is capable of receiving and at least temporarily holding a fluid (which as used herein denotes any substance capable of flowing, as may include liquids, liquid suspensions, gases, gaseous suspensions, or the like, without limitation).

The rigid portion 14 includes a first receiver 16 for receiving and holding a fluid-agitating element 18 at a home location (or expected position) when positioned in the bag 10. It is noted that “holding” as used herein defines both the case where the fluid-agitating element 18 is directly held and supported by the first receiver 16 (see below) against any significant side-to-side movement (save tolerances), as well as where the first receiver 16 merely limits the fluid-agitating element to a certain degree of side-to-side movement within the bag 10. In this embodiment, an opening 18a is provided in the fluid-agitating element 18 and the first receiver 16 is a post 20 projecting toward the interior of the bag 10 (see FIGS. 1a and 1b). The post 20 is sized for receiving the fluid-agitating element 18 by extending through the opening 18a formed in the body 18b thereof (which is depicted as being annular, but not necessarily circular in cross-section). As illustrated in FIG. 1, it is preferable that the size of the opening 18a is such that the fluid-agitating element 18 may freely rotate and move in the axial direction along the post 20 without contacting the outer surface thereof. Despite this freedom of movement, the post 20 serving as the first receiver 16 is still considered to hold, confine, or keep the fluid-agitating element 18 at a home location or expected position within the vessel 20 by contacting the surface adjacent to the opening 18a as a result of any side-to-side movement (the boundaries being defined by the dimensions of the opening).

The flexible portion 12 of the bag 10 may be made from one or more sheets of thin (e.g., having a thickness of between 0.1 and 0.2 millimeters) polyethylene film secured together to define a compartment for receiving the fluid. Preferably, the film used is clear or translucent, although the use of opaque or colored films is also possible. The rigid portion 14 including the post 20 may be formed of plastic materials, such as high density polyethylene (HDPE), ultrahigh molecular weight (UHMW) polyethylene, or like materials. Of course, these materials do have some inherent flexibility when used to form relatively thin components or when a moderate amount of bending force is applied. Despite this flexibility, the rigid portion 14 is distinguished from the flexible portion 12, in that it generally maintains its shape under the weight of fluid introduced in the bag 10.

Optionally, the post 20 may include a portion 20a for capturing the fluid-agitating element 18 and assisting in holding it thereon. The portion 20a is preferably oversized and forms the head or end of the post 20. By “oversized,” it is meant that at least one dimension (length, width, diameter) of this portion 20a of the post 20 is greater than the corresponding dimension of the opening 18a in the fluid-agitating element 18. For example, the portion 20a is shown in FIG. 1 as being disc-shaped, such that it provides the head end of the post 20 with a generally T-shaped cross section. To prevent interference with the levitation and rotation of the fluid-agitating element 18, the oversized portion 20a is strategically positioned at a certain distance along the post 20. In the case where it is oversized, the post 20 may be removably attached to the rigid portion 14 through the opening 18a in the fluid-agitating element 18 (such as by providing a threaded bore in the rigid portion for receiving a threaded end of the post, or as shown in FIG. 1c, a bore 14a having a groove 14b for establishing a snap-fit engagement with a corresponding projection 20b on a tapered end portion 20c of the post). In the case where the post 20 is unitarily formed with the rigid portion 14 and includes an oversized head portion 20a, this portion should be sufficiently thin such that it flexes or temporarily deforms to allow the fluid-agitating element 18 to pass initially (see FIG. 1b and note the deforming of the oversized head 20a as it passes the opening 18a).

Alternatively, this portion 20a of the post 20 may simply be sufficiently close in size to that of the opening 18a such that the fluid-agitating element 18 must be precisely aligned and register with the post 20 in order to be received or removed. In any case, the fluid-agitating element 18 is held in place adjacent the post 20, but remains free of direct attachment. In other words, while the first receiver 16 (post 20) confines or holds the fluid-agitating element 18 at a home location or expected position within the bag 10, it is still free to move side-to-side to some degree (which in this case is defined by the size of the opening 18a), and to move along the first receiver 16 in the axial direction (vertical, in the embodiment shown in FIG. 1), as is necessary for levitation.

As perhaps best shown in FIG. 1a, the rigid portion 14 in this embodiment further includes a substantially planar peripheral flange 22. This flange 22 may be any shape or size, and is preferably attached or connected directly to the bag 10 at the interface 1 between the two structures (which may be created by overlapping the material forming the flexible portion 12 of the bag on an inside or outside surface of the flange 22 to form an overlapping joint, or possibly in some cases by forming a butt joint). In the case where the bag 10 and flange 22 are fabricated of compatible plastic materials, the connection may be made using well-known techniques, such as ultrasonic or thermal welding (heat or laser) at the interface to form a seal (which is at least liquid-impervious and preferably hermetic). Alternatively, other means of connection (e.g., adhesives), may be used at the interface 1, although this is obviously less preferred in view of the desirability in most cases for the more reliable, leak-proof seal afforded using welding techniques. In either case, the judicious use of inert sealants may be made along the joint thus formed to ensure that a leak-proof, hermetic seal results. As discussed further below, the need for an interface may be altogether eliminated by simply affixing the rigid portion 14 to an inside or outside surface of the bag 10.

As should be appreciated, the bag 10 shown in FIG. 1 may be manufactured as described above, with the fluid-agitating element 18 received on the post 20 (which may be accomplished using the techniques shown in FIGS. 1b and 1c). The empty bag 10 may then be sealed and folded for shipping, with the fluid-agitating element 18 held at the home location by the post 20. Holding in the axial direction (i.e., the vertical direction in FIG. 1) may be accomplished by folding the bag 10 over the post 20, or by providing the portion 20a that is oversized or very close in size to the opening 18a in the fluid-agitating element 18.

When ready for use, the bag 10 is then unfolded. It may then be placed in a rigid or semi-rigid support structure, such as a container C, partially open along at least one end such that at least the rigid portion 14 remains exposed (see FIG. 2). Fluid F may then be introduced into the bag 10, such as through an opening or fitting (which may be a sterile or aseptic fitting, in the case where the bag 10 is pre-sterilized or otherwise used in a sterile environment). As should be appreciated, in view of the flexible or non-rigid nature of the bag 10, it will generally occupy any adjacent space provided in an adjacent support structure or container C when a fluid F (liquid or gas under pressure) is introduced therein (see FIG. 2).

An external motive device 24 or “drive unit” is then used to cause the fluid-agitating element 18 (which is at least partially magnetic or ferromagnetic) to at least rotate to agitate any fluid F in the bag 10. In the embodiment of FIG. 2, the fluid-agitating element 18 is at least partially magnetic and is shown as being levitated by the motive device 24, which is optional but desirable. As described in my U.S. Pat. No. 6,758,593, the disclosure of which is incorporated herein by reference, the levitation may be provided by a field-cooled, thermally isolated superconducting element SE (shown in phantom in FIG. 2) positioned within the motive device 24 and thermally linked to a cooling source (not shown). As also described therein, the fluid-agitating element 18 may then be rotated by rotating the superconducting element SE (in which case the fluid-agitating element 18 should produce an asymmetric magnetic field, such as by using at least two spaced magnets having alternating polarities). Another option is to use a separate drive structure (e.g., an electromagnetic coil) to form a coupling capable of transmitting torque to the particular fluid-agitating element (which may be “levitated” by a hydrodynamic bearing; see, e.g., U.S. Pat. No. 5,141,327 to Shiobara). While it is of course desirable to eliminate the need for a dynamic seal or opening in the bag through which a drive structure (such as a shaft) extends, the particular means used to levitate and/or rotate the fluid-agitating element 18 is not considered critical.

The fluid-agitating element 18 is also depicted as including a plurality of vanes or blades B to improve the degree of fluid agitation. If present, the vanes or blades B preferably project in a direction opposite the corresponding surface of the rigid portion 14. The particular number, type, and form of the vanes or blades B is not considered important, as long as the desired degree of fluid agitation for the particular application is provided. Indeed, in applications where only gentle agitation is required, such as to prevent damage to delicate suspensions or to merely prevent stagnation of the fluid F in the bag 10, the vanes or blades B need not be provided, as a rotating smooth-walled annular element 18 may still provide a modest degree of agitation.

As explained above, it may be desirable to not only know the general location or position of the fluid-agitating element 18 within the bag 10, but also to assure its position relative to the motive device 24. To do so, the rigid portion 14 may be provided with a second receiver 26 to facilitate the correct positioning of the motive device 24 relative to the fluid-agitating element 18 when held at the home location. In the embodiment shown in FIGS. 1a and 1b, the second receiver 26 takes the form of a locator projection or second post 28 extending in a direction opposite the first post 20. Preferably, the second post 28 is essentially coaxial with the first post 20 (although the post 20 may be a separate component that fits into a receiver 14a defined by the second post 28 (see FIG. 1c) or vice-versa) and is adapted to receive an opening 24a, such as a bore, in the adjacent head portion 24b forming a part of the housing for the motive device 24. Consequently, the second post 28 helps to assure that the alignment between the fluid-agitating element 18 (which is generally held in the vicinity of the first receiver 16/post 20, which is the home location) and the motive device 14 is proper to create the desired coupling.

Preferably, the second receiver 26, such as post 28, has a cross-sectional shape corresponding to the shape of the opening 24a. For example, the second post 28 may be square in cross-section for fitting in a correspondingly-shaped opening 24a or locator bore. Likewise, the second post 28 could have a triangular cross-sectional shape, in which case the opening 24a would be triangular. A myriad of other shapes could also be used, as long as the shape of the second receiver 26 complements that of the opening 24a such that it may be freely received therein. In this regard, it is noted that a system of matching receivers and openings may be used to ensure that the fluid-agitating element 18 in the bag 10 corresponds to a particular motive device 24. For example, in the case where the fluid-agitating element 18 includes a particular arrangement of magnets producing a magnetic field that corresponds to a particular superconducting element or drive structure, the second receiver 26 may be provided with a certain shape that corresponds only to the opening 24a in the motive device 24 having that type of superconducting element or drive structure. A similar result could also be achieved using the relative sizes of the second receiver 26 and the opening 24a, as well as by making the size of the opening 18a such that it only fits on a first receiver 16 having a smaller width or diameter, and then making the second receiver 26 correspond to an opening 24a in a motive device 24 corresponding to that element 18.

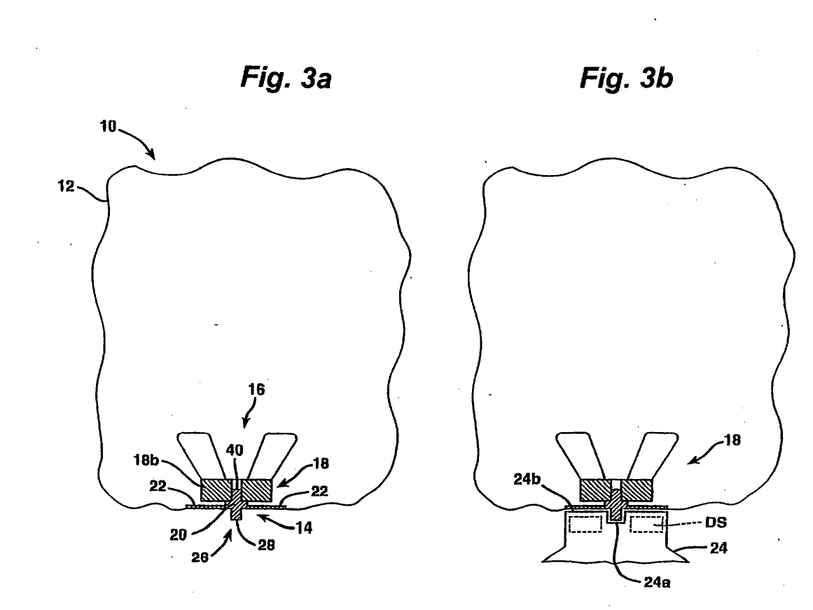

Up to this point, the focus has been on a fluid-agitating element 18 capable of levitating in the vessel. However, as briefly noted above, the inventions described herein may also be applied to a bag 10 in combination with a fluid-agitating element 18 directly supported by one or more bearings. For example, as shown in FIGS. 3a and 3b, the first receiver 16 associated with the rigid portion 14 of the bag 10 may be in the form of an inwardly-projecting post 20 including a slide bearing 40 for providing direct support for the fluid-agitating element 18. The bearing 40 is preferably sized and shaped such that it fits into an opening 18a forming in the fluid-agitating element 18, which may rest on the adjacent surface of the post 20 or may be elevated slightly above it. In either case, it should be appreciated that the first receiver 16 receives and holds the fluid-agitating element 18 in a home location, both during shipping and later use.

In view of the direct nature of the support, the material forming the slide bearing 40 is preferably highly wear-resistant with good tribological characteristics. The use of a slide bearing 40 is preferred in applications where the bag 10 is disposable and merely discarded after used, since it is less expensive than a corresponding type of mechanical roller bearing (and is actually preferred even in the case where the bag 10 is reused, since it is easier to clean). However, it is within the broadest aspects of the invention to provide the first receiver 16 with a conventional roller bearing for providing direct, low-friction, rolling support for the rotating fluid-agitating element 18, although this increases the manufacturing expense and is unacceptable in certain applications.

The rigid portion 14 of the bag 10 in this embodiment may further include a second receiver 26 in the form of a second post 28 coextensive and coaxial with the first post 20. The second post 28 is received in the opening 24a formed in a head end 24b of a motive device 24. In view of the direct support provided for the fluid-agitating element 18 by the bearing 40, the motive device 24 in this case includes only a drive structure DS (shown in phantom in FIG. 3b) for forming a coupling with the body 18b, which is magnetic. The drive structure DS may be a permanent magnet or may be ferromagnetic, as necessary for forming the coupling with the fluid-agitating element 18, which may be disc-shaped, cross-shaped, an elongated bar, or have any other suitable shape. The drive structure DS may be rotated by a direct connection with a motor (not shown), such as a variable speed electric or, pneumatic, or hydraulic motor, to induce rotation in the fluid-agitating element 18. Alternatively, the drive structure DS may be an electromagnet with windings to which current is supplied to cause the magnetic fluid-agitating element 18 rotate and possibly levitate slightly to create a hydrodynamic bearing (see, e.g., U.S. Pat. No. 5,141,327, the disclosure of which is incorporated herein by reference). Again, it is reiterated that the particular type of motive device 24 employed is not considered critical.

In many past arrangements where a rigid metal vessel receives a fluid-agitating element directly supported by a bearing, an external structure is provided to which a motive device could be directly or indirectly attached and held in a suspended fashion (see, e.g., U.S. Pat. No. 4,209,259 to Rains et al., the disclosure of which is incorporated herein by reference). This structure serves automatically to align the motive device with the fluid-agitating element supported therein. However, a bag 10 per se is generally incapable of providing reliable support for the motive device 24, which can weigh as much as twenty kilograms. Thus, the motive device 24 in the embodiments disclosed herein for use with a vessel in the form of a bag 10 is generally supported from a stable support structure, such as the floor, a wheeled, height adjustable elevated stand or platform (e.g., a dolly, see below), or the like. Since there is thus no direct attachment with the bag 10, the function performed by the second receiver 26 in aligning this device 24 with the fluid-agitating element 18 is an important one.

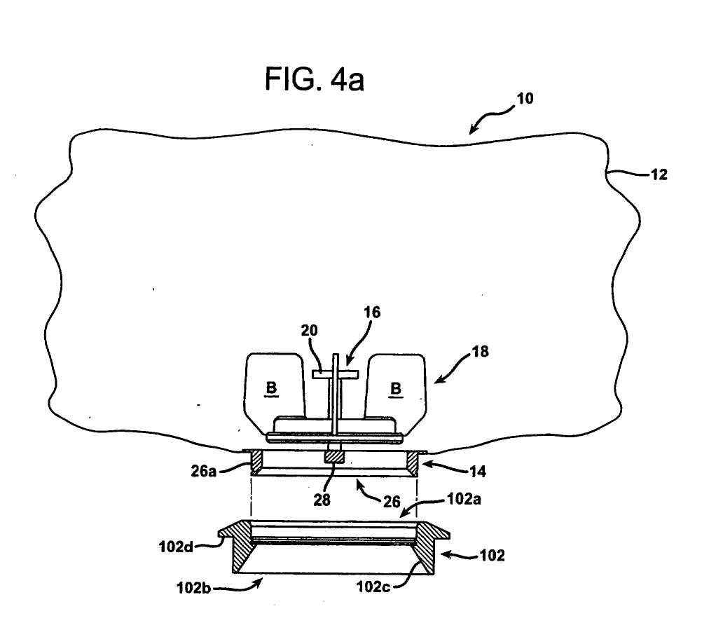

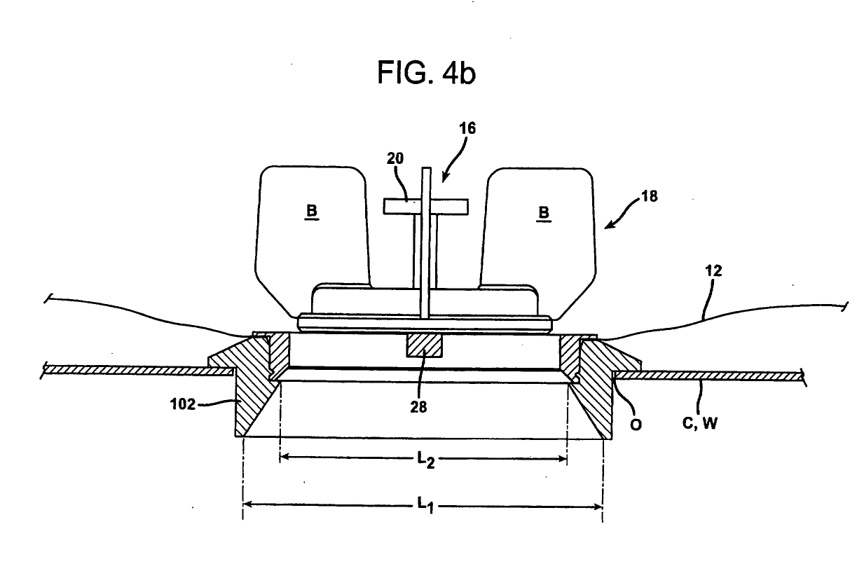

Even though the motive device 24 may be supported by the floor, it may still be desirable to ensure that the proper alignment with the fluid agitating element 18 is reliably achieved in an expedient fashion. Accordingly, various alignment devices, systems, and related methods are disclosed for this purpose. Turning first to FIGS. 4a and 4b, a first embodiment of an alignment system 100 includes an alignment device in the form of an interface 102. The interface 102 in this embodiment includes a first end 102a adapted for associating with the second receiver 26 forming part of the rigid portion 14 of the bag 10. In particular, this receiver 26 may include an annular locator projection 26a that fits into a matching opening formed in the first end 102a of the interface 102 and thus helps to locate the fluid-agitating element 18 externally. The fit between the projection 26a and the first end 102a of the interface 102 is preferably mechanical engagement, such as a press or interference fit, snap fit, or even a threaded coupling. Alternatively, a bayonet fitting or like arrangement could be used, but this obviously complicates the arrangement.

The opposite or second end 102b of the interface 102 is tubular and includes an opening adapted for receiving the head end 24b of the motive device 24, which may be correspondingly shaped and, if circular, preferably has an outer diameter slightly less than the inner diameter of the corresponding end of the interface 102. Preferably, the inside surface 102c adjacent the entrance of this opening tapers in the vertical direction from a larger dimension L₁ to a smaller dimension L₂, and when in the form of a hollow cylinder is thus generally frusto-conical. The interface 102 also includes a peripheral flange 102d, shown located between the ends 102a, 102b.

Accordingly, with reference to FIG. 4b, the interface 102 in use is received in an opening O formed in a bottom sidewall W of a rigid container C for receiving the bag 10, which may be empty. The interface 102 may be installed in the opening O before the bag 10 is placed in the container C, in which case the receiver 26 is simply attached to the interface 102. Instead, the interface 102 may first be attached to the receiver 16 of the bag 10 and then passed through the opening O. Still another option is to associate the interface 102 with an adjacent stand and simply pass it through the opening O. In any case, the first receiver 16 holds the fluid-agitating element 18 at the desired or home location in the bag 10, while the second end 102b of the interface 102 provides alignment function for the external motive device 24 (the head end 24b thereof, in particular) and ensures that the proper coupling is formed for agitating the fluid (especially if a locator bore 24a is present, since the second post 28 essentially extends the first, inwardly projecting post 20). This includes during initial insertion of the head end 24b or like portion of the motive device 24 into the second end 102b, where the frusto-conical surface 102c provides a guiding and centering function.

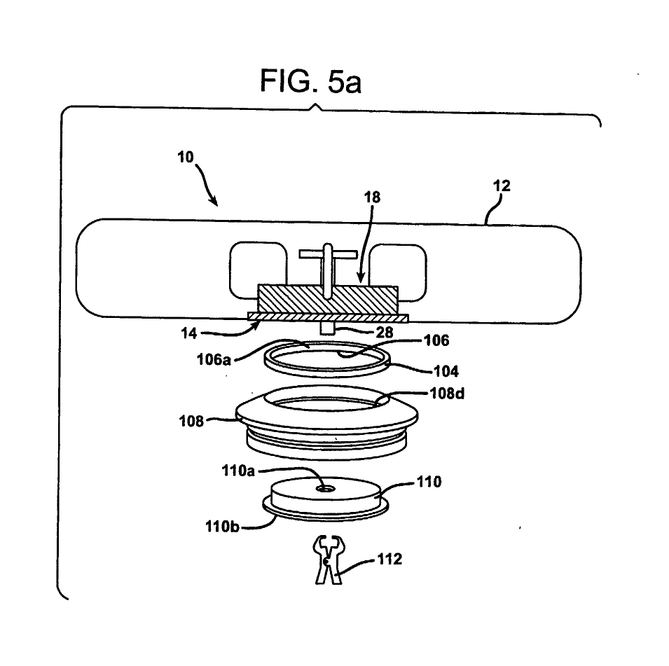

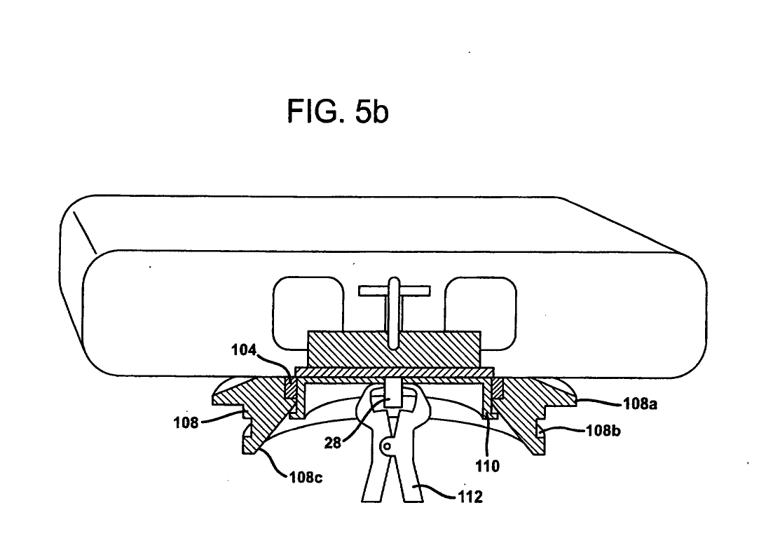

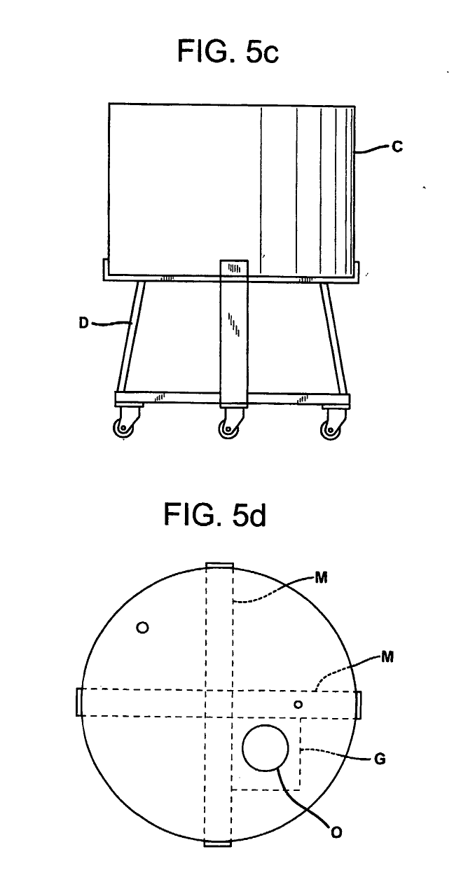

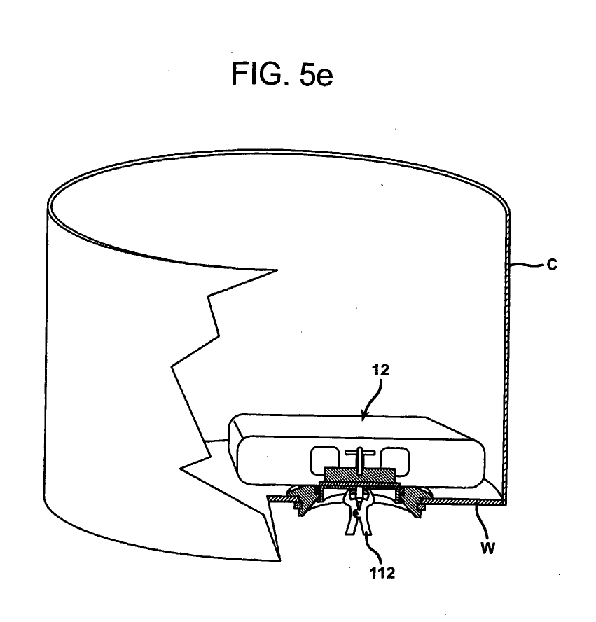

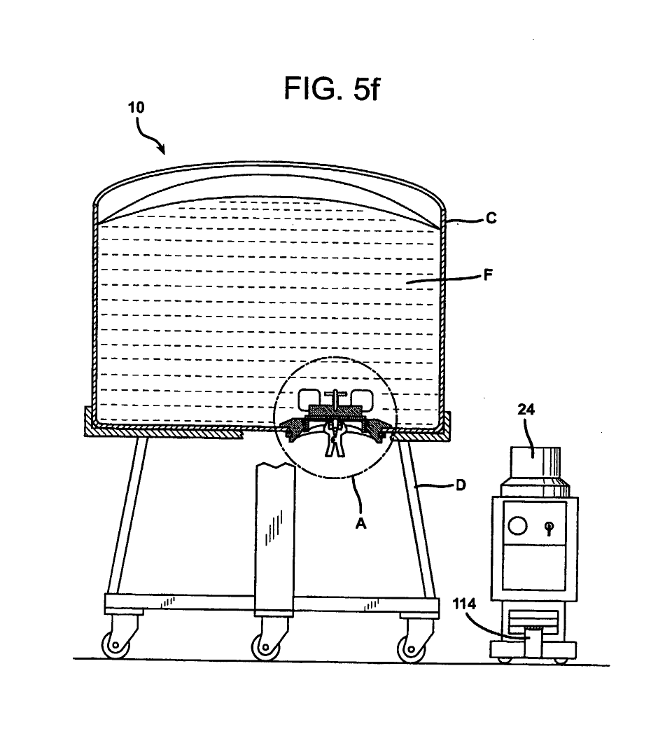

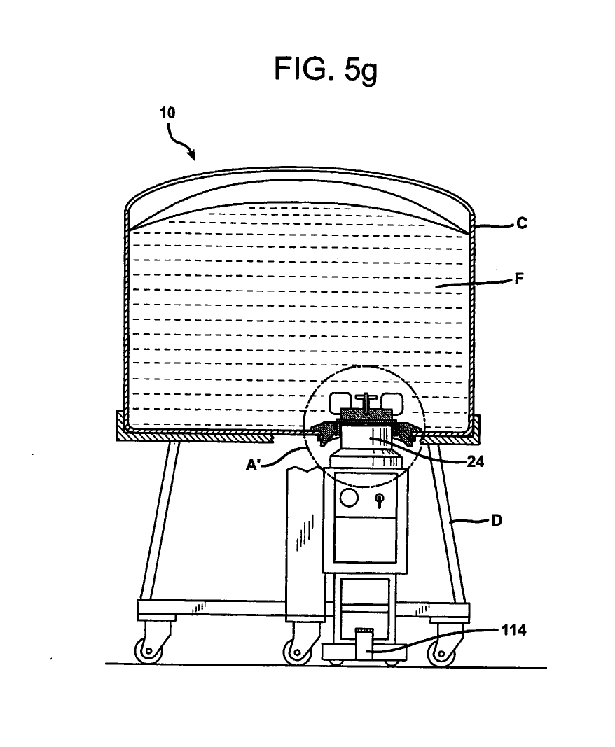

In some arrangements, including where the rigid container C is particularly tall, it may be difficult to reach the bottom sidewall W or floor from above and establish the desired engagement between the rigid portion 14 of the bag 10 and the interface 102 in the opening O. Thus, in other embodiments, the interface 102 may be formed of multiple component parts, which helps to alleviate this problem. For example, the interface 102 of the second embodiment shown in Figures 5a and 5b comprises three parts. Specifically, it includes: (1) a first “aligner” part 104 with a relatively thin, planar face portion or film 106 having a center aperture 106a for receiving the locator projection 28 of the flexible bag 10 through the opening O; (2) a support part 108 adapted for engaging the container C, receiving the aligner part 104 along one end, and receiving at least a portion of the motive device 24 along the other; and (3) a cup or cap-shaped receiver part 110 designed to engage the support part 108 and also including a center aperture 110a for receiving the locator projection 28. In these figures, the bag 10 is undersized for purposes of illustration only.

In use, and with specific reference to FIG. 5b-5g, the support part 108 is associated with the opening O in the rigid container C, which as shown in FIG. 5d may be offset from the center in order to accommodate the cross members M (shown in phantom) of an associated dolly D or like support structure. Specifically, the support part 108 includes a peripheral flange 108a for engaging the container C adjacent the opening O in the sidewall W. A depending portion of the support part 108 projecting through the opening O in use may also include a groove 108b for receiving a sealing ring or similar elastic retainer (not shown). As with the first embodiment, a tapered or frusto-conical surface 108c assists in guiding and centering the motive device 24.

Next, the aligner part 104 may be associated with the support part 108, which preferably includes a correspondingly shaped and sized seating surface 108d concentric with the aperture 106a. Once in place, the second receiver 26 such as the locator projection or post 28 associated with the bag 10 is inserted through the aperture 106a, which is centered and thus concentric with the periphery of the aligner part 104. Accordingly, this serves to center the second receiver 26/post 28 relative to the aligner part 104, and thus the first receiver 16 for the fluid-agitating element 18.

Finally, the receiver part 110 is inserted through the other external end of the support part 108, with the post 28 passing through the aperture 110a. The receiver part 110 includes a structure for engaging the support part 108, such as a peripheral flange 110b, and is preferably sized to form a press or slide fit with the aligner part 104. When the assembly is complete, an optional holder or holding means, such as an alligator clamp 112 having a pair of opposed, biased jaws, may be associated with the exposed end of the post 28. This holds the assembly A or alignment system until a sufficient amount of the fluid (e.g., liquid) is present.

Turning to FIGS. 5f and 5g, when the bag 10 is filled with a fluid F in the form of a liquid, the hydrostatic pressure forces the flange 108a of the support part 108 into tight seating engagement with the container C. The aligner part 104 is captured between the support part 108 and the rigid portion 14 of the bag 10, and holds the receiver part 110 in place. The holder, such as clamp 112, may then be removed and the motive device 24 moved into alignment with the open end of the interface 102 defined by the support part 108 and the receiver part 110. The head end 24b of the motive device 24 is moved into this end sufficient to form the desired coupling between the associated drive structure, such as a magnet (not shown), and the fluid-agitating element 18. In the embodiment shown, this is done using a linear mover, such as a jack screw 114, associated with the motive device 24, which thus completes the assembly A′. Precise, reliable alignment between the head end 24b of the motive device 24 and the fluid-agitating element 18 is thus guaranteed with minimal installation effort and no guesswork.

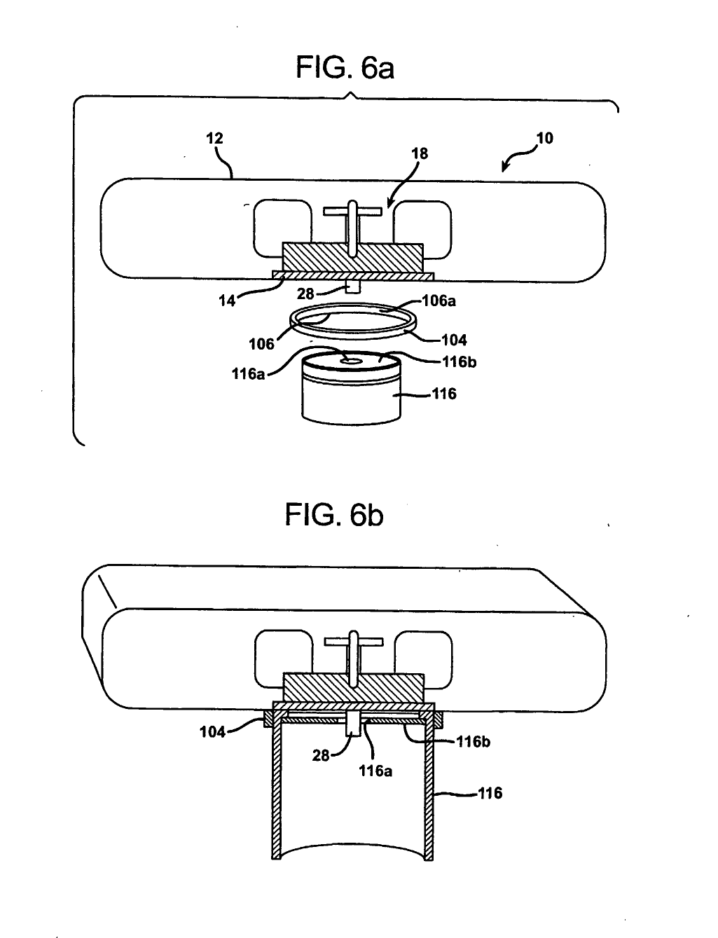

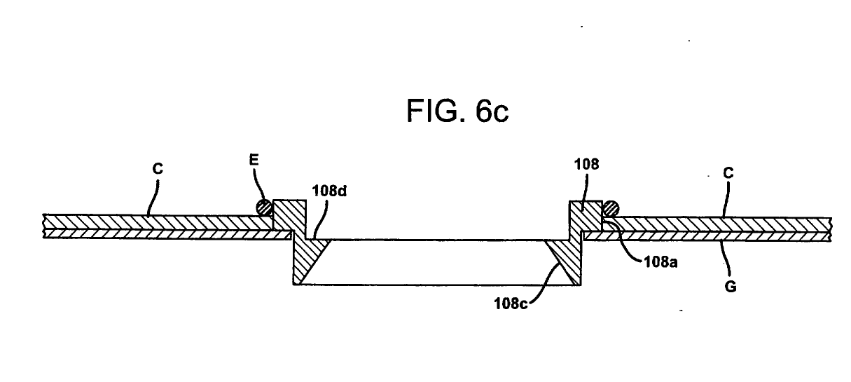

FIGS. 6a, 6b and 6c relate to a third embodiment of the interface 102, which also includes multiple component parts. In this embodiment, the aligner part 104 is substantially as described above and includes a planar face 106 having a center aperture 106a. However, the support part 108 is carried by a base G associated with the dolly D (see FIG. 5d) and sized to fit within the opening O of the container C. This part 108 also includes a seating surface 108d. A holder 116 or holding means having a tubular body with a first end including a center aperture 116a in an at least partially magnetic plate 116b attractive to the fluid-agitating element 18.

In use, the aligner part 104 associates with the bag 10 such that the second receiver 26, such as post 28, passes through the aperture 106a in the face portion 106. The holder 116 is then positioned such as the receiver 26/post 28 passes through the concentric aperture 116a. The plate 116b proximate the magnetic fluid agitating element 18 may thus form a coupling and sandwich the aligner part 104 between the holder 116 and the rigid portion 14 of the bag 10.

The holder 116 may then be passed through the support part 108 in the opening O of the container C, which may be temporarily held in place along a peripheral surface of a flange 108a by an elastic band E or the like (which may optionally include a corresponding receiver or groove (not shown)). The bag 10 may then at least partially filled with liquid while the magnetic coupling is maintained with the fluid-agitating element 18. The hydrostatic pressure forces the aligner part 104 into tight seating engagement with the seating surface 108d of the support part 108 and holds it centered in place. The holder 116 may then be removed by breaking the magnetic coupling and the motive device 24 only then moved into engagement with aligner part 104, with the tapered or frusto-conical surface 108c of the support part 108 providing initial guidance. Consequently, precise, reliable alignment results in a foolproof manner with ease and without guesswork.

As should be appreciated, the various embodiments of the interfaces 102 described facilitate use of the same motive device 24 or drive unit with multiple container C and bag 10 arrangements. As described further below, the motive device 24 may be supported on a wheeled cart and moved to a position for alignment with and insertion in the corresponding end of the interface to form the desired coupling with the fluid-agitating element 18 in the bag 10. When the particular operation is complete, the motive device 24 may be disassociated with the interface 102 and associated with a different interface of a different container and bag arrangement in a similar fashion. The interface 102 thus facilitates the use of the same motive device 24 with multiple mixing “stations,” each including a rigid container C with a flexible bag 10.

Instead of moving the motive device 24 to a different container, it is also possible to simply disassociate the bag 10 once the particular operation is completed in a given container C. The bag 10 can then be removed and a different one placed in the new container C. Once the fluid-agitating element 18 in the substitute bag is properly aligned with the motive device 24, with the assistance of any one of the interfaces 102 described above, the mixing process may commence. As should be appreciated, this process may be repeated as necessary or desired, potentially without the need for ever separating the motive device 24 from the associated container C.

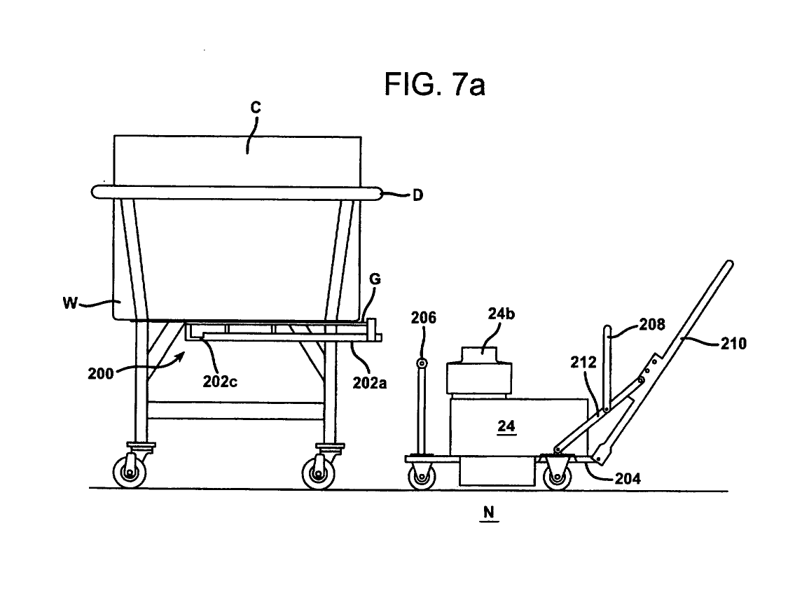

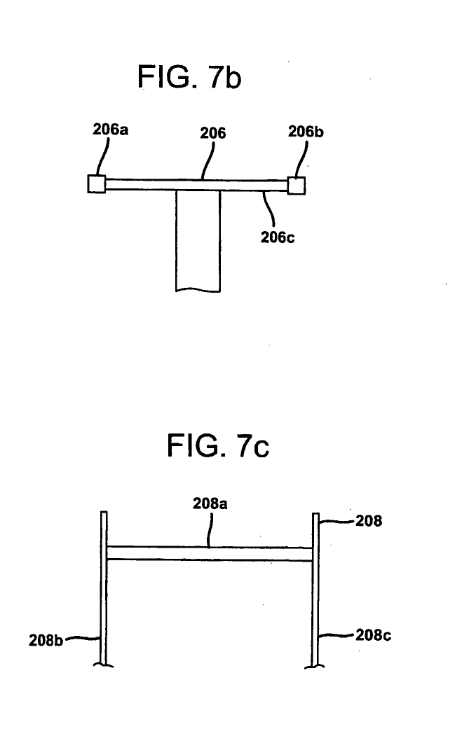

Turning now to FIGS. 7a-7c, another aspect of the invention for aligning the motive device 24 with the fluid-agitating element 18 is disclosed. In this embodiment, the elevated stand or dolly D for the rigid container C includes a guide 200 for guiding the motive device 24 into alignment with the opening O, which may be associated with any of the three embodiments of the interface 102 described above or an equivalent structure. In the preferred embodiment, the guide 200 includes a pair of spaced, elongated, generally parallel rails 202a, 202b carried by the dolly D adjacent the bottom wall W of the container C. Specifically, the rails 202a, 202b may be suspended above the floor or ground N from a base G supported by the dolly D, which base may also carry the support part 108 associated with the third embodiment of the interface 102. Each rail 202a, 202b preferably includes a notch 202c adjacent the terminal end.

The motive device 24 associates with a first bearing structure 206 adjacent a first end and a second bearing structure 208 adjacent a second, preferably opposite end. A preferably wheeled cart 24, which is considered optional, includes a handle 210 for manually moving the motive device 24 about, which handle is shown as supporting the second bearing structure 208. The height of the cart 204 may be such that at least the first bearing structure 206 and the associated motive device 24 may pass under the guide rails 202a, 202b depending from the dolly D.

In the preferred embodiment, the first bearing structure 206 includes a pair of rollers or wheels 206a, 206b supported by a cross member 206c and spaced apart to correspond to the guide rails 202a, 202b. The second bearing structure 208 also includes a cross member 208a, as well as support members 208b, 208c spaced apart a distance at least slightly greater than the spacing of the rails 202a, 202b associated with the dolly D.

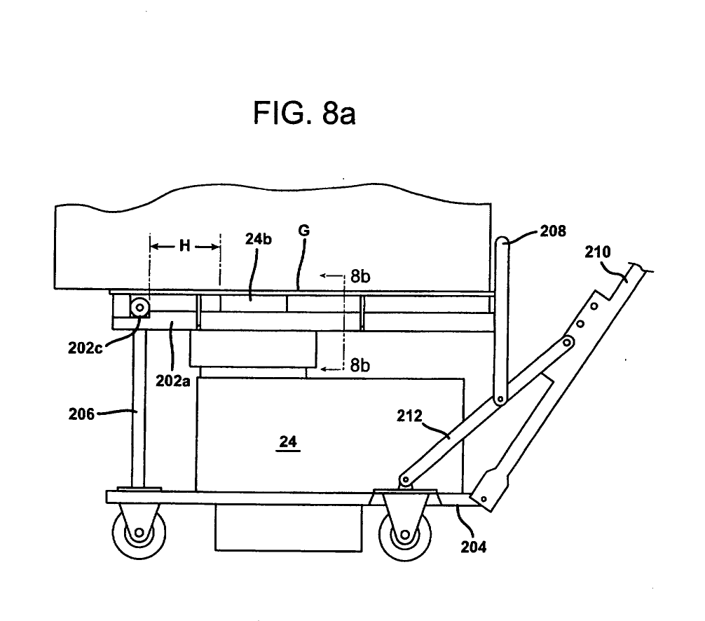

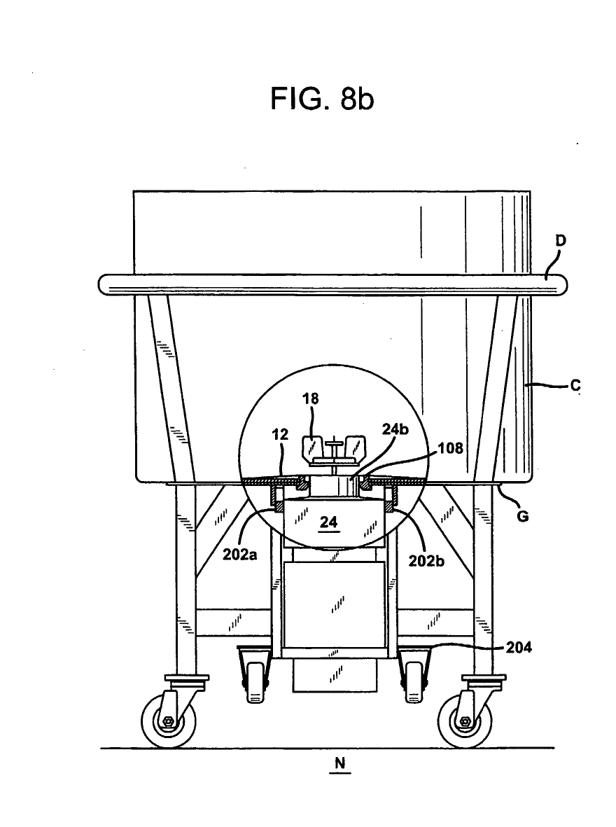

In use, the handle 210 may be used to tilt the cart 204 to move the rollers 206a, 206b into engagement with the guide rails 202a, 202b. The cart 24 is then advanced under the dolly D until the rollers 206a, 206b reach the terminal end and become captured by the associated notch 202c. Preferably, the leading edge of each notch 202c in the longitudinal direction of the rails 202a, 202b is spaced from the trailing edge of the external opening in the interface 102 about the same distance H that the rollers 206a, 206b are spaced from the adjacent edge of the head end 24b of the motive device 24 (see FIG. 8a).

Once the terminal end is reached, the head end 24b of the motive device 24, although canted and spaced from it, is substantially aligned with the opening 0, which in the illustrated embodiment lies substantially in the center of the container C. The operator may pivot the cart 204 using the handle 210 to associate the second bearing 208 and, in particular, the cross member 208a, with the proximal ends of the guide rails 202a, 202b, and thus “hang” or suspend the motive device 24 from the dolly D (see FIG. 8a). As this is done, the head end 24b of the motive device 24 engages the frusto-conical or tapered surface adjacent the external entrance of the interface 102 and is thus guided to the propercentered position therein (with the rollers 206a, 206b free to move within the notches 202c if necessary to achieve the proper alignment). As described above, this results in precise alignment with the fluid-agitating element 18, as shown in the partially cross-sectional portion of FIG. 8b (noting to avoid confusion the reorientation of the swiveling wheels of the dolly D). The motive device 24 is then actuated to rotate the fluid-agitating element 18 adjacent the head end 24b and agitate any fluid present in the bag 10.

With reference to FIGS. 7a and 8a, the second bearing 208 may be supported by spaced generally parallel linkages 212 associated with the handle 210. Multiple connection points may be provided adjacent the handle 210 for the adjacent end of these linkages 212. This of course allows for the position of the second bearing 208 to be adjusted to accommodate variations in the height of the guide 200, but is considered entirely optional.

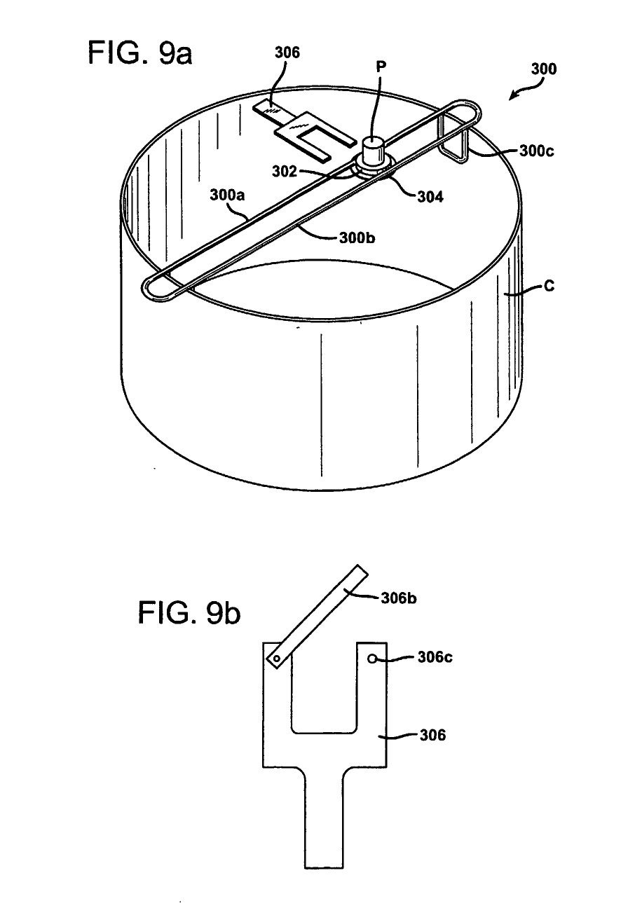

While the foregoing discussion has primarily focused on aligning the drive unit or motive device 24 with the agitator 18, flexible bags of the type for use in mixing systems frequently include one or more ports with screw caps along the opposite or upper end for introducing substances to the fluid, usually in the form of powders. An example of a bag 10 with a single port P is shown in FIG. 9a. In some cases, the operator may need to access this “powder” port P before the bag 10 is filled with fluid and it lies adjacent to the bottom wall W of the container C, which can be tedious. Moreover, after the bag 10 is filled with a liquid, the port P if open must always be maintained above the upper surface level or else deleterious leakage results. As should be appreciated, it may be difficult for a single operator to hold the open port P above the liquid surface while simultaneously removing (e.g., unscrewing) the cap and introducing a powder, etc.

Accordingly, another aspect of the alignment systems, devices, and methods of the present invention comprises a support structure 300 for any port P associated with the bag. In the embodiment illustrated in FIG. 9a, the structure 300 includes a pair of interconnected, spaced apart, generally parallel, elongated rails 300a, 300b adapted for spanning the open end of the rigid container C or tank and engaging the top edge or rim thereof at two spaced locations. An optional depending portion 300c engages the interior of the container C, such as along the sidewall.

The preferred form of the port P for use in this embodiment includes first and second flanges 302, 304 spaced apart in the vertical direction. The first or upper flange 302 is sized to pass through the elongated opening defined by the spaced rails 300a, 300b such that the cap of the port P projects between and preferably through them. The lower flange 304 may be similarly shaped, but sized to engage the underside of the rails 300a, 300b.

Once the port P receives the support structure 300 in this fashion, it is then captured and held against movement in the vertical direction. In the preferred embodiment, this is accomplished using a means for associating the port with the support structure 300, which may comprise a coupler for coupling the port P with the support structure 300, which could be a hook and chain, flexible band, spring, or like structure. In one embodiment, this coupler takes the form of a fork 306, wrench, or like bifurcated structure for slidably engaging the underside of the first or upper flange 302 and the upper side at least one and preferably both of the rails 300a, 300b. In this position, the fork 306 thus captures and holds the port P, preventing it from falling below the surface level of the liquid (which of course is typically below the horizontal plane defined by the upper end of the container C). The cap associated with the port P may then be removed without difficulty or fear of significant liquid spillage.

Preferably, the fork 306 includes a handle 306a along one end to ease manual installation and removal. To ensure that the fork 306 is securely held in place once installed over the port P, an elastic band, O-ring, or like structure (not shown) may be placed over the bifurcated ends. Alternatively, as shown in FIG. 9b, a pivoting latching member 306b may be provided adjacent the open end of the fork 306 for receiving the port P. The latching member 308 may thus be pivoted to close the open end of the fork 306 around the port P, and may be held in place by a detent 306c, clip, or similar engagement structure. An optional biasing force may also be provided by a spring (not shown) for holding the latching member 308 in a normally-closed position.

Using this arrangement, it should be appreciated that accessing the port P is greatly facilitated, regardless of its location relative to the open end of the container C. This is because the operator may simply pass the port P through the opening between the rails 300a, 300b at any location along the length of the structure 300. Likewise, if the port P is not initially aligned for this purpose, the structure 300 can simply be moved along the rim of the container C until the appropriate position is reached (which holds true even if the container is square or rectangular in cross-section). Due to the lack of permanent attachment, the structure 300 may also be easily withdrawn for positioning a bag in the container C without significant effort.

As previously noted, the height of the container C may prevent the operator from being able to reach the bottom wall W or floor from an external position, regardless of the orientation. Since it is desirable to maximize the container capacity or volume without a concomitant increase in the footprint, the modern trend involves increasing the container height greater than thirty inches. This of course only compounds the reach problem. Tools could be used to extend the operator's reach, but this complicates the process.

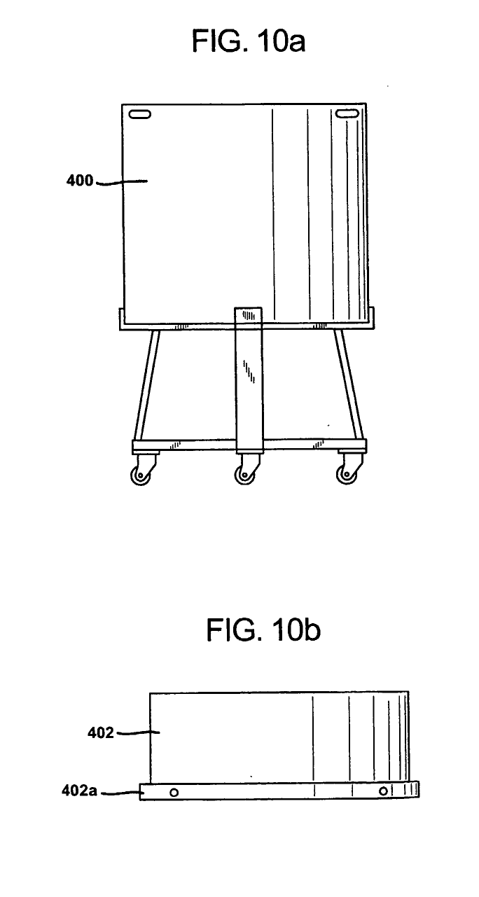

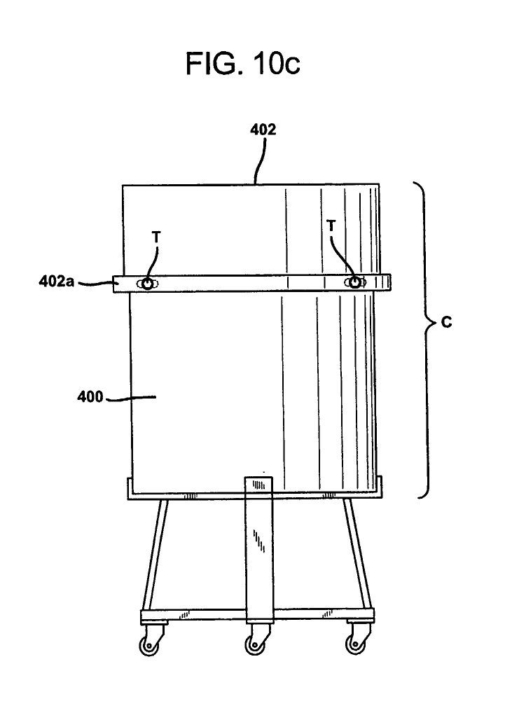

In an effort to alleviate this problem without compromising the mixing operation, a multi-part rigid container C for receiving the bag 10 is proposed. As shown in FIGS. 10a, 10b and 10c, the container C includes a base 400 and at least one extender 402. The extender 402 may also include an oversized flange 402a for receiving and/or engaging the periphery of the base 400 adjacent the rim portion when the two structures are mated. Of course, this arrangement could also be reversed, with the base 400 including the flange (not shown) for receiving the lower rim portion of the extender 402. Optional fasteners T, such as removable bolts, latches or bayonet fittings, may also be provided to secure each component of the container C together.

In any event, the extender 402 may be initially maintained separate from the base 400, which is of sufficiently low height (typically about thirty inches or less) to allow an operator to reach the floor or bottom wall W along the interior and install the bag (not shown) in the proper fashion. Once this is done, the upper end of the bag may be drawn up to and possibly through the open end of the base 400. The bag may then be optionally filled up to about the height of the base 400. The extender 402 is then temporarily moved into the mated position, the corresponding end of the bag may be passed through its open end, and the filling operation may be completed (or filling may commence, if not previously done up to about the height of the base 400). As should be appreciated, additional extenders similar to the one shown may then be added as necessary to accommodate the vertical dimension of a given bag or a corresponding volume of fluid, and the process may be repeated as described in the foregoing passage.

Any powder port (not shown) may be secured using the support structure 300, if desired. Instead, the bag (not shown) may simply be filled with fluid to a height that exceeds the vertical dimension of the base 400 of the container C without negative consequence. Once the mixing operation is complete and the bag removed, the extender 402 may simply be removed and the above-described sequence repeated, if desired.

Obvious modifications or variations are possible in light of the above teachings. For example, instead of forming the rigid portion 14 as part of the bag 10 by forming a seal at an interface between the two, it could also be positioned in contact to an inner or outer surface of the bag and attached using vacuum-forming techniques, adhesives, or the like. Instead of a cart 204, the first and second bearings 206, 208 could be supported directly by the motive device 24, which could also include a handle 210 to facilitate suspending it from the stand or dolly D. The guide 200 could also be carried by the container C instead of the dolly D or stand without negative operational consequence. It is also possible to provide any of the first receivers with a tapered or frusto-conical engagement surface for mating with a corresponding surface on the fluid-agitating element, as disclosed in patent application Ser. No. PCT/US01/31459, incorporated herein by reference.

The foregoing descriptions of various embodiments of the present inventions have been presented for purposes of illustration and description. These descriptions are not intended to be exhaustive or to limit the invention to the precise forms disclosed. The embodiments described provide the best illustration of the principles of the invention and its practical applications to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled.

1. An alignment system for use with a motive device for a fluid-agitating element in a flexible bag and a rigid container including an opening through which a coupling may be formed between the fluid-agitating element and the motive device, comprising:
a locator projection for associating with the bag adjacent the fluid-agitating element and the opening in the container; and
an interface having a first end for receiving the locator projection and a second end for receiving at least a portion of the motive device,
whereby the interface assists in aligning the locator projection and hence the adjacent fluid-agitating element with the motive device through the opening.

2. The system according to claim 1, wherein the first end of the interface includes a planar face including a center aperture for receiving the locator projection.

3. The system according to claim 1, wherein the second end of the interface is tubular and includes a tapered surface for guiding the motive device into alignment with the fluid-agitating element.

4. The system according to claim 1, wherein the first end of the interface comprises a first part and the second end comprises a second part for engaging the first part.

5. The system according to claim 1, further including means for holding the interface adjacent the locator projection.

6. The system according to claim 5, wherein the holding means comprises a clamp including jaws for gripping a portion of the locator projection adjacent the first end of the interface.

7. The system according to claim 5, wherein the fluid-agitating element is at least partially magnetic, and the holding means forms a magnetic coupling with the fluid-agitating element to hold the first end of the interface adjacent the locator projection.

8. The system according to claim 1, wherein the interface is attached to and supported by the rigid container in use.

9. The system according to claim 1, wherein the interface is attached to and supported by the bag in use.

10. The system according to claim 1, further including a stand for supporting the rigid container, wherein the stand includes a support part for positioning in the opening of the rigid container and engaging the interface.

11. The system according to claim 1, wherein the motive device is associated with a first bearing and further including a stand for supporting the container, said stand including a guide for receiving the first bearing, wherein the terminal end of the guide corresponds to a generally aligned position of a portion of the motive device for positioning adjacent the fluid-agitating element.

12. The system according to claim 11, wherein the guide is comprised of a pair of spaced rails, each including a notch adjacent the terminal end for capturing the first bearing such that a portion of the motive device for positioning adjacent the fluid-agitating element substantially aligns with the opening in the container.

13. The system according to claim 11, wherein the first bearing is positioned adjacent a first end of the motive device and a second end of the motive device is associated with a second bearing for engaging a corresponding end of the stand to suspend the motive device therefrom.

14. In a mixing system including a fluid-agitating element rotated by an external motive device in a vessel including a locator projection adjacent the fluid-agitating element, an alignment device comprising:
an interface having a first end for receiving the locator projection and a second end for receiving at least a portion of the motive device, said second end including a tapered surface for guiding the motive device into alignment with the fluid-agitating element.

15. The alignment device according to claim 14, wherein the first end of the interface includes a planar face with a center aperture for receiving the locator projection.

16. The alignment device according to claim 14, wherein the first end of the interface comprises a first part and the second end comprises a second part for engaging the first part.

17. The alignment device according to claim 14, further including means for holding the interface adjacent the locator projection.

18. In a mixing system in which an external motive device rotates a fluid-agitating element in a flexible bag having a locator projection, a device for supporting and aligning the bag relative to the motive device, comprising:
a rigid container for receiving the bag, the container including an opening associated with an interface having a tapered surface for guiding the motive device into alignment with the locator projection through the opening.

19. The device according to claim 18, wherein a first end of the interface includes a planar face having a center aperture for receiving the locator projection.

20. The device according to claim 18, wherein a first end of the interface comprises a first part and the second end comprises a second part for engaging the first part.

21. The device according to claim 18, further including means for holding the interface adjacent the locator projection.

22. A support arrangement for a rigid container for receiving a flexible bag including a fluid-agitating element capable of being rotated by a motive device, comprising:
a stand for receiving and supporting the container, the stand supporting a guide adjacent the opening for guiding the motive device into alignment with the fluid-agitating element through the opening when the bag is positioned in the container.

23. The support arrangement according to claim 22, wherein the motive device is associated with first and second bearing structures and the guide comprises a pair of spaced rails for engaging the bearing structures such that the motive device is suspended from the stand.

24. The support arrangement according to claim 23, wherein each guide rail includes a notch adjacent a terminal end thereof for receiving an associated portion of the first bearing structure.

25. The support arrangement according to claim 22, wherein the stand further includes a base having a first opening for receiving an interface for assisting in aligning the fluid-agitating element with the motive device through a second opening in the container.

26. The support arrangement according to claim 25, wherein the interface includes a tapered surface for guiding the motive device during installation.

27. In a mixing system including a fluid-agitating element rotated in a flexible bag by an external motive device, the bag having a port and being positioned in a rigid container, an alignment device comprising:
an elongated support structure for spanning between spaced ends of the container, the support structure including an elongated opening for receiving the port; and
means for associating the port with the support structure, whereby the port is supported by the support structure adjacent the rigid container.

28. The alignment device according to claim 27, wherein the support structure includes a depending portion for engaging an inner surface of the container at each spaced end.

29. The alignment device according to claim 27, wherein the port or a portion of the bag adjacent the port includes a first flange and the associating means includes a bifurcated end having a first side for engaging the first flange and a second side for engaging an upper surface the support structure.

30. The alignment device according to claim 29, wherein the associating means includes a second flange for engaging a lower surface of the support structure.

31. The mixing system according to claim 29, wherein the associating means includes a pivoting member for capturing the flange therein.

32. In a mixing system including a fluid-agitating element rotated by an external motive device in a flexible bag, a rigid container for supporting the bag, comprising:
an open-ended upstanding base having a floor and an opening for exposing the fluid-agitating element in the bag to the motive device; and
a temporary extender for removably mating with the open end of the base to increase the capacity of the container,
wherein the extender may be removed for manually accessing the floor along an interior of the container.

33. The container according to claim 32, wherein the extender includes a peripheral flange for receiving a portion of the base.

34. The container according to claim 32, wherein the opening is in the floor of the base.

35. A method of aligning a motive device with a fluid-agitating element in a flexible bag through an opening in a rigid container, comprising:
associating a first end of an interface with a locator projection carried by the bag; and
associating a second end of the interface with the motive device;
whereby the interface assists in aligning the locator projection and hence the fluid-agitating element with the motive device through the opening in the rigid container.

36. The method of claim 35, further including inserting the locator projection through a center aperture formed in a planar face at a first end of the interface.

37. The method of claim 35, wherein the second end of the interface is tubular for receiving the motive device and includes a tapered surface, and the method comprises engaging a head end forming part of the motive device at least partially with the tapered surface during the step of associating the second end of the interface in order to establish alignment with the fluid-agitating element.

38. The method of claim 35, further including the step of assembling the interface from a first part including the first end and a second part including the second end.

39. The method of claim 35, further including coupling the interface with the bag adjacent the locator bore.

40. The method of claim 39, wherein the coupling step comprises forming a magnetic coupling between an external holder and the fluid-agitating element in the bag.

41. The method of claim 35, further including the step of associating the interface with the opening in a floor of the rigid container.

42. The method of claim 35, further including the step of suspending the motive device from a stand for supporting the container and in substantial alignment with the second end of the interface.

43. A method of aligning a motive device with a fluid-agitating element in a vessel, comprising:
associating a first end of an interface with the vessel; and
associating a second tapered end of the interface with the motive device;
whereby the tapered surface assists in aligning the fluid-agitating element with the motive device.

44. A method for supporting and aligning a motive device with a fluid-agitating element positioned in a flexible bag carrying a locator projection and rotated by an external motive device, comprising:
positioning the bag in a rigid container including an opening associated with an interface having a tapered surface for guiding the motive device into alignment with the locator projection through the opening.

45. A method of supporting a rigid container for receiving a flexible bag including a fluid-agitating element capable of being rotated by a motive device, comprising:
associating the motive device with a guide adjacent an opening in the rigid container in alignment with the fluid-agitating element in the bag; and
forming a magnetic coupling between the motive device and the fluid-agitating element.

46. The method of claim 45, wherein the associating step comprises suspending the motive device from the guide, and the method further includes moving the motive device into alignment with the opening before or during the suspending step.

47. The method of claim 45, further including the step of associating the motive device with a different container.

48. The method of claim 45, further including the step of associating the motive device with a different flexible bag.

49. The method of claim 45, further including the step of aligning the motive device with the fluid-agitating element through an interface adjacent the opening in the container before or during the forming of the magnetic coupling.

50. A method of suspending a port of a bag in a rigid container, comprising:
spanning an elongated support structure including an elongated opening for slidably receiving the port between spaced ends of the container, and
connecting the port with the support structure.

51. The method of claim 50, wherein the step of connecting the port comprises passing a coupler having a bifurcated end between a flange adjacent the port and the support structure.

52. The method of claim 50, further including moving the port along the elongated opening before the connecting step.

53. The method of claim 50, wherein the spanning step comprises positioning the elongated support structure in general alignment with the port.

54. A method of forming a rigid container for supporting a bag including a fluid-agitating element rotated by an external motive device to mix a fluid contained therein, comprising:
providing a base with an open end and having an opening in a sidewall for exposing the fluid-agitating element in the bag to the motive device;
mating an extender with the base to increase the capacity of the container; and
removing the extender from the base.

55. The method according to claim 54, wherein the mating step comprises positioning a portion of the base within a peripheral flange associated with the extender.

56. The method according to claim 54, wherein the sidewall is a floor and the method further includes coupling the fluid-agitating element with the external motive device through the opening.
